(19) United States
(12) Patent Application Publication
(10) Pub. No.: US 2015/0162641 A1
(43) Pub. Date: Jun. 11, 2015

(54) PROTECTED LITHIUM ELECTRODES HAVING A LIQUID ANOLYTE RESERVOIR ARCHITECTURE AND ASSOCIATED RECHARGEABLE LITHIUM BATTERY CELLS

(71) Applicant: PolyPlus Battery Company, Berkeley, CA (US)

(72) Inventors: Steven J. Visco, Berkeley, CA (US); Vitaliy Nimon, San Francisco, CA (US); Yevgeniy S. Nimon, Danville, CA (US); Bruce D. Katz, Moraga, CA (US); Lutgard C. De Jonghe, Lafayette, CA (US); Alexei Petrov, Walnut Creek, CA (US)

(21) Appl. No.: 14/565,249

(22) Filed: Dec. 9, 2014

Related U.S. Application Data
(60) Provisional application No. 61/913,834, filed on Dec. 9, 2013.

(51) Int. Cl. H01M 10/056

(52) U.S. Cl. CPC H01M 10/056

(57) ABSTRACT

The present invention is directed to protected active metal negative electrodes for use in an electrochemical device such as a rechargeable battery cells, and to novel battery cells incorporating said protected electrodes. In accordance with the invention, the interior of the anode compartment includes, what is termed herein, a reservoir architecture for accommodating liquid anolyte in contact with the active metal electroactive material layer and is spatially engineered to improve service life of the instant electrode, and in particular embodiments to enhance cycle life of a battery cell in which the protected electrode is employed.

### CROSS-REFERENCE TO RELATED APPLICATIONS

This application claims priority to U.S. Provisional Patent Application No. 61/913,834 filed Dec. 9, 2013, titled PROTECTED LITHIUM ELECTRODES HAVING A POROUS RESERVOIR STRUCTURE AND RECHARGEABLE LITHIUM BATTERY CELL STRUCTURES, which is incorporated herein by reference in its entirety and for all purposes.

### FIELD OF THE INVENTION

The present invention relates generally to the field of electrochemical devices and components thereof. In particular, the present invention is directed to rechargeable active metal battery cells, and cell components, including protected active metal negative electrodes.

### BACKGROUND OF THE INVENTION

Portable electronic devices, electric vehicles and renewable energy storage are driving the demand for batteries that are lighter, smaller, longer lasting and lower cost than conventional lithium ion. To achieve some or all of these objectives new electro-active materials, electrolytes and/or a shift in battery cell chemistry and/or cell architecture is needed.

Batteries are based on electrochemical reactions taking place on or nearby a pair of electrodes known individually as the anode and cathode, and more generally as the negative and positive electrode respectively. In a conventional lithium battery, be it rechargeable or primary, the negative and positive electrodes are separated from direct contact by a porous separator or gel layer, which is imbibed with a liquid electrolyte medium that directly contacts both electrodes, and therewith, closes the ionic circuit of the cell by providing a contiguous for lithium ion migration between the electrodes. Accordingly, such conventional lithium batteries have a cell architecture that is termed herein as a “common electrolyte architecture” wherein the liquid electrolyte is common to, and in contact with, both the anode (negative) and cathode (positive) electrodes. With but a single liquid electrolyte exposed to both electrodes, a significant advantage of the common electrolyte architecture is simplicity. However, this comes at the sacrifice of material flexibility and choice, as electrode and electrolyte choice and optimization is severely constrained by the two-fold requirement that both the anode and cathode be chemically compatible in contact with a singular electrolyte.

Work in the present assignees' laboratories has developed protected lithium electrode technology that enables a variety of practical battery cell architectures including that which has been termed herein and elsewhere as a “dual electrolyte system” or “dual electrolyte architecture,” whereby the two-fold electrode compatibility requirement is circumvented. As its term suggests, the dual electrolyte system includes a pair of electrolytes: i) a first electrolyte in contact with the anode but which does not contact the cathode (i.e., anolyte); and ii) a second electrolyte in contact with the cathode but which does not contact the anode (i.e., catholyte). The advent of protected lithium electrode technology generally, and the dual architecture system in particularly, has enabled a broad new class of lithium batteries, which were hitherto impractical, including: lithium water, lithium air and aqueous lithium sulfur battery cells. Moreover, the use of a dual electrolyte system, enabled by assignee's protected lithium electrode technology, allows for optimizing the anode/anolyte combination independent of the choice of cathode and catholyte, and vice versa as it pertains to optimizing the cathode/catholyte combination.

The aforesaid protected lithium electrode and battery cell technology has led to the practical realization of advanced secondary lithium battery cell chemistries which pair high-energy cathode/catholyte combinations with highly electronegative lithium anode electrodes. Such secondary batteries have shown remarkably high specific energy, and there is a need to further advance the technology for long term cycling, consistent with that currently achievable by conventional lithium ion batteries. The present invention addresses this need by providing novel protected electrodes and battery cell structures for extending the cycle life of active metal battery cells and, in particular, protected lithium electrodes with extended cycling capability and battery cells thereof having improved cycle life.

### SUMMARY OF THE INVENTION

In one aspect the invention provides a protected active metal negative electrode for use in an electrochemical device such as a rechargeable battery cell. In various embodiments the instant protected electrode is incorporated into a battery cell as an integrated component, and in some particular embodiments the protected electrode is integrated with the battery cell housing. However, the invention is not limited as such, and in other embodiments the protected negative electrode is incorporated in the battery cell as a discrete component therein.

In accordance with the aforesaid protected negative electrode aspect of this invention, the protected negative electrode includes what is termed herein as an electrochemically functional hermetic anode compartment wherein an active metal anode electroactive layer and a liquid anolyte (i.e., liquid electrolyte in contact with the anode electroactive layer) are operably disposed for electrochemistry, but otherwise isolated from the external environment about the anode compartment, for which constituents of the external environment may include other battery cell components (e.g., catholyte which is electrolyte in contact with the cathode electrode (i.e., positive electrode) and/or moist air during cell manufacture or operation of a cell having an open to air construction).

It should be understood that the term anode electrode (i.e., anode) and cathode electrode (i.e., cathode) are sometimes interchangeably used herein and elsewhere with the term negative electrode and positive electrode, respectively. Moreover, when using the term liquid anolyte it is meant liquid electrolyte which contacts the anode electroactive material but does not contact the electroactive material of the cathode, and when using the term catholyte it is meant electrolyte which contacts the cathode electroactive material but which does not contact the anode electroactive material or the anode electroactive layer thereof.

The active metal electroactive layer of the anode has first and second major opposing surfaces, wherein at least the first surface provides an electrochemically active interface with the liquid anolyte. In various embodiments the electroactive layer is a lithium electroactive layer, especially a lithium metal layer such as a lithium metal foil or sintered sheet, typically a dense lithium metal layer. However, the invention is not limited to dense electroactive metal layers, and in other embodiments the electroactive layer may be a porous layer comprising electroactive material such as active metal intercalation materials such as carbons capable of intercalating and de-intercalating lithium ions (i.e., lithium intercalation materials), and other such materials including lithium alloys such as lithium-silicon alloys and the like. When the electroactive layer of the anode is a lithium electroactive layer (e.g., lithium metal foil), the liquid anolyte is a non-aqueous liquid electrolyte chemically compatible in direct contact with lithium metal.

The electroactive layer and liquid anolyte are disposed within the interior confines of the anode compartment, and as such the anode compartment has what may be termed herein an anode compartment wall structure. In various embodiments the wall structure of the anode compartment is composed of: i) a peripheral negative electrode sidewall component that surrounds the periphery of the electroactive layer and is configured to hermetically interface with a negative electrode cover plate component and a substantially impervious solid electrolyte membrane component to form the anode compartment. For instance, the aforesaid wall structure components may be adhered to each other using hermetic seals such as a heat seal and/or epoxy seal and/or mechanical pressure seals (e.g., a gasket seal).

In accordance with aspects of this invention, a component of the anode compartment wall structure is a substantially impervious active metal ion conducting membrane that is sometimes more simply referred to herein and elsewhere as a solid electrolyte membrane or even more simply herein and in the claims as a or the membrane. According to this aspect, the membrane is an important component of the anode compartment as it provides the medium through which active metal ions may migrate into and out of the anode compartment.

In various embodiments the protected negative electrode is “double-sided,” and rather than have a cover plate, the protected negative electrode has a wall structure that is composed of two substantially impervious solid electrolyte membranes that hermetically interface with the sidewall to form the anode compartment. By this expedient, the protected anode has two opposing solid-state mediums that serve as ionic pathways for the ionic migration of active metal ions into/out of the compartment (i.e., it is double-sided)

The anode cover plate is typically an impervious rigid body, whereas in various embodiments (including both double-sided and single-sided protected anodes) the sidewall, also impervious, may be rigid or flexible.

With the anode compartment hermetic, the interior components of the compartment, such as the electroactive layer and liquid phase anolyte, do not come into direct contact (i.e., touching contact) with any external constituents. However, the compartment, electrochemically functional, does provide at least a first ionic pathway for migration of active metal ions into and out of the compartment as well as an electronic pathway for the through conduction of electrons. Moreover, the liquid phase anolyte within the interior of the compartment serves as an active metal ion-conducting medium to support electrical migration of active metal ions between the solid electrolyte membrane and the electroactive layer.

In various embodiments the protected active metal negative electrode is a protected lithium negative electrode, wherein the active metal ion is lithium, the electroactive layer is a lithium electroactive layer (e.g., a lithium foil or sintered sheet, or lithiated material such as lithiated carbon or lithium alloy such as a lithium-silicon alloy), and the liquid phase anolyte is a non-aqueous electrolyte (e.g., the anolyte comprising an organic solvent in combination with a lithium salt dissolved therein, or a suitable ionic liquid), and the solid electrolyte membrane has a high lithium ion conductivity, preferably greater than 10⁻⁵ S/cm. In various embodiments thereof the protected active metal negative electrode is double-sided and has a flexible sidewall component. In other embodiments the protected negative electrode is single sided, and in embodiments thereof the sidewall is rigid or in other embodiments flexible.

In accordance with the invention, the interior of the anode compartment further includes, what is termed herein, a reservoir architecture for accommodating the liquid anolyte and is designed to improve service life of the instant electrode, and in particular embodiments to enhance cycle life of a battery cell in which the protected electrode is employed.

A significant feature of the reservoir architecture is that it has a spatially engineered pore structure that takes advantage of capillary forces to drive liquid anolyte toward the lithium surface while driving solid and gaseous reaction products away therefrom, and, in particular, the spatially engineered pore structure drives said reaction products to a region within the anode compartment that is remotely positioned away from the electroactive lithium surface, and in certain embodiments remotely positioned away from what is termed herein as an “interlayer region,” which is a spatial region bound by, and therein existing between, the lithium surface and the substantially impervious solid electrolyte membrane. By this expedient the reservoir architecture facilitates maintenance of an electrochemically effective lithium metal/liquid anolyte interface that provides benefit of improved cycle performance for a battery cell in which the protected electrode is employed or integrated therewith.

In accordance with the invention, the reservoir architecture includes: i) a porous material network (i.e., porous network) that, devoid of electroactive material, comprises at least a porous material layer component (e.g., a porous material film) disposed on the surface of the electroactive layer (e.g., lithium metal foil surface) and positioned between the electroactive layer and the solid electrolyte membrane, and thus oftentimes referred to herein as the porous material interlayer or more simply as the porous interlayer or interlayer; and ii) a reservoir for accommodating liquid phase anolyte beyond that which is present in the porous material interlayer. The volume of anolyte in the reservoir can exceed (i.e., is greater than) the total pore volume of the interlayer. In accordance with the invention, the network is engineered such that the various component materials and mediums of the porous network are in pore communication with each other. Moreover, the reservoir architecture itself is engineered within the anode compartment to maintain liquid flow communication between liquid anolyte that is present in the porous network with that (i.e., liquid anolyte) which is present in the reservoir.

In various embodiments the volume of the reservoir available for receiving liquid anolyte, or otherwise the amount of liquid anolyte in the reservoir, is 30%-1000% larger than the pore volume of the interlayer material; for instance 30%-100% or 200-1000%.

In various embodiments the reservoir is or includes a porous medium in pore communication with the porous material interlayer and therefore is considered herein as a component of the porous material network, and, as such, is referred to herein as a porous reservoir medium component or more simply as a porous-reservoir medium or even more simply as the reservoir medium. In various embodiments the porous-reservoir medium defines the reservoir itself, and, as such, the reservoir, or more generally the anode compartment, is substantially devoid of any open space or gaps. Moreover, the porous-reservoir medium has a pore volume that is typically substantially larger than the pore volume of the interlayer material. In various embodiments the pore volume of the reservoir medium is 30-1000% larger than the pore volume of the porous interlayer; for instance 30-100% or 200-1000%.

In other embodiments the protected negative electrode has a reservoir that is devoid of a porous material component, and, as such, the reservoir is essentially a region of open space within the compartment that is filled with liquid anolyte, and in such said embodiments the reservoir is sometimes referred to herein as an open-space-reservoir. Importantly, it should be understood that, when present, the open-space-reservoir is not merely inadvertent gaps or voids in the anode compartment, but is rather a spatially engineered open space that not only allows for anolyte communication between itself (the reservoir) and the porous material interlayer, but also drives liquid anolyte toward the lithium surface and reaction products away therefrom.

In various embodiments the protected negative electrode includes a reservoir is a remote reservoir that is remotely positioned outside the confines of an interlayer-region defined by the region bounded by, and therein existing between, the electroactive layer and the solid electrolyte membrane.

In various embodiments the protected negative electrode is single-sided and has a remote reservoir, as defined above, which comprises a porous reservoir medium that is a material layer adjacently disposed between the cover plate component and a current collector layer, typically dense.

In various embodiments the protected negative electrode has a reservoir architecture wherein the reservoir is an interlayer-reservoir in that it is positioned within the confines of an interlayer region (as defined above), and which, the interlayer-reservoir comprises a discrete porous medium in direct contact with the solid electrolyte membrane, and wherein the discrete porous-reservoir medium is configured in pore communication with the porous interlayer.

In various embodiments the remotely positioned reservoir includes a porous medium that, as a component of the porous material network, is configured in pore communication (and preferably capillary communication) with the porous interlayer.

In various embodiments, the reservoir architecture has a porous material network that is simply the porous interlayer material comprising liquid anolyte and an open space reservoir wherein the liquid anolyte in the reservoir is in flow communication with the liquid anolyte of the interlayer. Moreover, the volume of the open-space reservoir is typically substantially larger than the pore volume of the interlayer material. In various embodiments the volume of the open space reservoir is 30-1000% larger than the pore volume of the interlayer material; for instance 30-100% or 200-1000%.

In accordance with the invention, the reservoir architecture as a whole, and in particular the reservoir and various porous materials/mediums of the porous network are devoid of electroactive material, and that the electroactive layer, porous or otherwise, is not considered to be a component of the porous material network. As such, the porous material network of the reservoir architecture constitutes a discrete component of the protected anode, the network distinct from that of the electroactive layer, and as such each discrete from the other.

In various embodiments the protected negative electrode has a pore structure comprising a porous material network that is engineered such that the pore radii increases in a direction moving away from the lithium surface.

In various embodiments the porous material network include a porous-reservoir medium. In various embodiments the porous material network includes a porous interconnecting element that establishes pore communication between the reservoir medium and the porous interlayer. In certain embodiments the total pore volume of the porous reservoir medium is derived from pores having pore radii that are larger than the pore radii of the pores that makeup the pore volume of the interlayer. In certain embodiments the pore structure of the porous material network is engineered such that the radii of pores constituting at least 80-95% of the total pore volume of the reservoir medium are larger than the pore radii constituting at least 80-95% of the total pore volume of the interlayer. In certain embodiments the pore structure of the porous material network is engineered such that the radii of pores constituting at least 80-95% of the total pore volume of the reservoir medium are at least a certain factor larger than the radii of pores constituting at least 80-95% of the total pore volume of the interlayer, wherein said factor is selected from the group consisting a factor of 2 times larger, 10 times larger, 100 times larger, and 1000 times larger. In certain embodiments the pore structure of the porous material network is engineered such that regions nearby the porous inter-connecting element is substantially devoid of empty space having a volume that is larger than the largest pores of the inter-connecting element. In certain embodiments thereof 80-95% of the pore radii which constitute the total pore volume of the inter-connecting element are larger than 80-95% of the pore radii which constitute the total pore volume of the interlayer and are smaller than 80-95% of the pore radii which constitute the total pore volume of the reservoir medium. In certain embodiments, substantially all of the pores disposed in the inter-connecting element have radii larger than the pore radii of substantially all of the pores of the interlayer, and, moreover, substantially all of the pores of the inter-connecting element have radii smaller than the pore radii of substantially all of the pores of the reservoir medium.

In various embodiments the reservoir architecture of the protected negative electrode has a remote open-space reservoir that is substantially devoid of a porous medium, and the open-space reservoir comprises liquid anolyte in liquid flow communication with the liquid anolyte of the interlayer. In certain embodiments the porous interlayer material extends into the open-space reservoir in direct contact with the liquid anolyte disposed in the reservoir. In certain embodiments the remote open-space reservoir is configured about the periphery of the electroactive layer. In certain embodiments the remote open-space reservoir is positioned adjacent the negative electrode cover plate and the current collector. And in embodiments thereof the protected anode further comprises a spring component positioned within the interior of the open-space reservoir, the spring component configured to provide positive pressure within the interior of the anode compartment for the purpose of maintaining electrochemically effective interfaces.

In various embodiments the instant protected electrode is double-sided, as defined above, and as such has two solid electrolyte membranes, and the liquid anolyte reservoir architecture includes a reservoir and two porous material networks, a first and a second porous material network, both comprising their own respective porous interlayer material, with the first-network porous interlayer component is disposed between the electroactive layer first surface and the first solid electrolyte membrane and the second-network porous interlayer component disposed between the electroactive layer second surface and the second-membrane first surface. Moreover, the liquid anolyte in the reservoir is in flow communication with the liquid anolyte disposed in the first-network porous interlayer component and/or the liquid anolyte disposed in the second-network porous interlayer component. In some embodiments, the volume of liquid anolyte in the anode compartment is greater than the combined total pore volume of the first-network and second-network porous interlayer components. In some embodiments, the volume of liquid anolyte in the reservoir is greater than the combined total pore volume of the first-network and second-network porous interlayer components.

In various of the double-sided protected negative electrode embodiments the liquid anolyte in the first and second network interlayers are both in flow communication with the liquid electrolyte in the reservoir, and the reservoir is a shared reservoir serving to provide a supply of liquid electrolyte to the surface of both electroactive layer surfaces. In certain embodiments the shared reservoir is remote (as defined above), and as such both the first and second networks are not disposed in an interlayer region. In certain embodiments the shared remote reservoir is an open-space reservoir substantially devoid of a porous medium, and the liquid anolyte in the shared reservoir is in liquid flow communication with the liquid anolyte of both interlayers.

In various embodiments the double-sided protected negative electrode has a sidewall that is flexible and thus operably compliant to thickness changes of the anode compartment.

In various embodiments the double-sided protected negative electrode has a first and second reservoir, the first reservoir in liquid anolyte flow communication with the first-network porous interlayer, and the second-reservoir in liquid anolyte flow communication with the second-network interlayer. In certain embodiments thereof the first and second reservoirs each comprise their own respective porous-reservoir medium. In certain embodiments the first and second porous-reservoir mediums are positioned within the confines of an interlayer region (as defined above).

In various embodiments the porous material network is a composite discrete porous bodies. In certain embodiments the porous material network is a composite of a discrete porous interlayer and a discrete porous-reservoir medium.

In accordance with various of the aforesaid embodiments, substantially all of the pore surfaces of the one or two porous material networks are readily wetted (wettable) by the liquid anolyte, and the contact angle is less than 90°.

In another aspect the invention provides battery cells comprising the instant protected negative electrodes. In various embodiments the protected negative electrodes are incorporated in the battery cells as discrete battery cell components. In other embodiments the protected negative electrodes are an integrated component of the battery cell. In particular embodiments the protected negative electrode sidewall is integral with the battery cell housing.

In accordance with the invention, in various embodiments the instant battery cells include a protected anode as described herein above and below, and a cathode electrode layer, an optional catholyte (typically liquid electrolyte), an optional separator component between the cathode electrode and the second surface of the solid electrolyte membrane (i.e., the surface opposing the cathode electrode), a positive electrode cover plate, a positive electrode feedthrough component and a peripheral positive electrode sidewall component surrounding the periphery of the positive electrode layer, the cathode sidewall configured to interface with the positive electrode cover plate and negative electrode sidewall to define a cathode compartment wherein the positive electrode layer, optional liquid catholyte, and optional separator component are disposed. Moreover, the positive electrode feedthrough component is configured to provide electronic communication between the interior and the exterior of the cathode compartment.

In certain embodiments the positive electrode sidewall component and negative electrode sidewall component is a unitary contiguous sidewall, the positive and negative sidewalls integral to each other. In other embodiments the positive and negative sidewall components are discrete sidewall components, hermetically interfacing (e.g., sealed) to each other.

In certain embodiments the positive electrode cover plate serves as the current collector for the positive electroactive layer, and may further function as the positive electrode feedthrough component.

In various embodiments the battery cell includes a double-sided protected negative electrode having a flexible sidewall component as described herein above and below. For instance, the battery cell further comprising a first and second positive electrode layer each comprising an optional first and second current collector in direct contact with their respective cathode layer, as well as: an optional liquid catholyte; an optional first and second separator component; a first and second positive electrode backplane component; a first and second positive electrode feedthrough component; a first and second peripheral positive electrode sidewall component surrounding the periphery of their respective positive electrode layer, the sidewalls configured to interface with their respective cover plate components to define a first and second cathode compartment wherein the respective first and second positive electrode layer and optional catholyte and optional separator are disposed; and further wherein the positive electrode feedthrough components are configured to provide electronic communication between the interior and the exterior of their respective cathode compartments; and even further wherein the first and second positive electrode sidewall components are rigid and configured to hermetically interface with the compliant negative electrode sidewall, such that the cathode compartments and the anode compartments are conjoined such that the cell thickness is compliant to changes in the thickness of the anode compartment.

In various embodiments, the battery cell has a double-sided protected negative electrode with a compliant sidewall and a first and second positive electrode sidewall component that are rigid and configured to hermetically interface with the compliant negative electrode sidewall, such that the cathode compartments and the anode compartments are conjoined such that the cell thickness is compliant to changes in the thickness of the anode compartment.

In various embodiments, the battery cell has a double-sided protected negative electrode with a compliant sidewall and a rigid outer cell housing and spring component; wherein the cell and spring component are disposed inside the cell housing, and the spring component is configured relative to an interior housing wall and one of the positive electrode cover plate components, with the spring exerting a positive pressure onto the cell for the purpose of maintaining electrochemically effective interfaces during cell operation.

In various embodiments, the battery cell has a double-sided protected negative electrode with a compliant sidewall and a rigid outer cell housing that is integral with the first and second positive electrode cover plate components, the rigid housing constraining the positive electrode sidewalls, and as such the compliant negative electrode sidewall is not compliant to changes in anode compartment thickness but is compliant to changes in anolyte volume.

In various embodiments, the battery cell has a double-sided protected negative electrode having a first and second porous material network, each having its own respective porous-reservoir medium, and the battery cell further comprises: a first and second positive electrode layer each comprising an optional current collector in direct contact; an optional liquid catholyte; an optional first and second separator component; a first and second positive electrode cover plate component; a first and second positive electrode feedthrough component; a first and second peripheral positive electrode sidewall component surrounding the periphery of their respective positive electrode layers, the sidewalls configured to interface with their respective cover plate components to define a first and second cathode compartment wherein the first and second positive electrode layers and optional catholyte and optional separators are disposed; and further wherein the positive electrode feedthrough components are configured to provide electronic communication between the interior and the exterior of their respective cathode compartments.

These and other aspects of the present invention are described in more detail, including with reference to figures, in the description which follows.

### BRIEF DESCRIPTION OF THE DRAWINGS

FIG. 1 is a schematic cross section of a protected anode and a battery cell in accordance with various embodiments of the present invention.

FIG. 2 is a schematic cross section of a protected anode and a battery cell in accordance with various embodiments of the present invention.

FIG. 3 is a schematic cross section of a protected anode and a battery cell in accordance with various embodiments of the present invention.

FIG. 4 is a schematic cross section of a protected anode and a battery cell in accordance with various embodiments of the present invention.

FIG. 5 is a schematic cross section of a protected anode and a battery cell in accordance with various embodiments of the present invention.

FIG. 6 is a schematic cross section of a protected anode and a battery cell in accordance with various embodiments of the present invention.

FIG. 7 is a schematic cross section of a protected anode and a battery cell in accordance with various embodiments of the present invention.

FIG. 8 is a schematic cross section of a protected anode and a battery cell in accordance with various embodiments of the present invention.

FIG. 9 is a schematic cross section of a protected anode and a battery cell in accordance with various embodiments of the present invention.

FIG. 10 is a schematic cross section of a protected anode and a battery cell in accordance with various embodiments of the present invention.

### DETAILED DESCRIPTION OF SPECIFIC EMBODIMENTS

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well known process operations have not been described in detail so as to not unnecessarily obscure the present invention.

When used in combination with “comprising,” “a method comprising,” “a device comprising” or similar language in this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

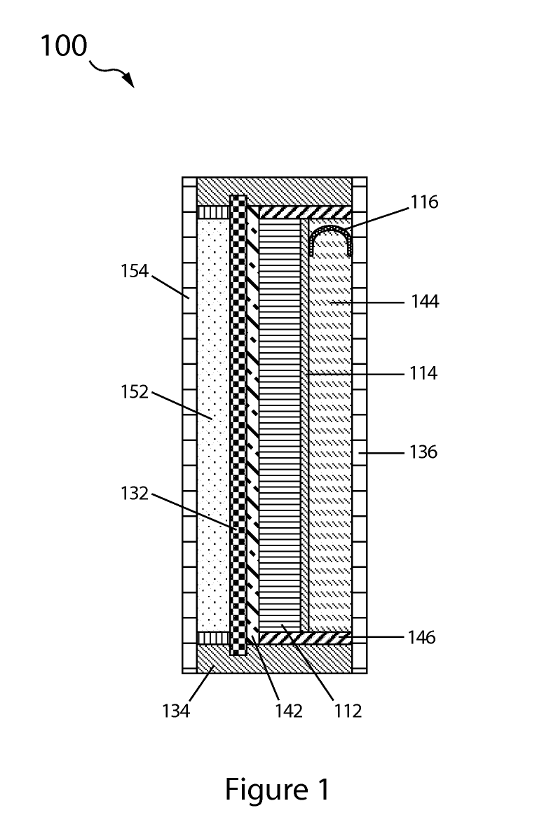

With reference to FIG. 1 there is illustrated a protected negative active metal electrode and a battery cell in accordance with the instant invention. The battery cell 100 includes a single-sided protected lithium electrode 110 and a cathode electrode 150. The protected lithium electrode includes a lithium electroactive layer 112 such as a lithium foil disposed inside an hermetic anode compartment 130 that is defined by a wall structure that includes a substantially impervious lithium ion conducting solid electrolyte membrane 132, a sidewall component 134 disposed about the periphery of the electroactive layer and a negative electrode cover plate 136. The wall structure components are hermetically sealed to each other. The sealing may include one or more of epoxy seals, heat seals and gasket seals. The sidewall may be rigid or flexible. For example the sidewall may be a rigid polymer or ceramic, or a flexible polymer or flexible multi-layer laminate material composed of polymeric and metal layers. The negative electrode cover plate is typically rigid, and may be electronically insulating or electronically conductive. For instance the cover plate may be an electronically insulating polymeric plate (e.g., a polyolefin or polyester plate) or an electronically conductive metal plate that may serve as an electronic feedthrough component in electronic communication with the electroactive layer.

Suitable substantially impervious solid electrolyte membrane components include the following:
(i) garnet-like compounds as described in PCT Patent Application WO 2013/010692 having Robert Bosch GMBH as applicant and inventors Eisele, Koehler, Hinderberger, Logeat, and Kozinsky and which is herein incorporated by reference for the disclosure of these suitable garnet-like compounds:
   Liₙ[A_{(3-a′-a″)}A′_{(a′)}A″_{(a″)}][B_{(2-b′-b″)}B′_{(b′)}B″_{(b″)}][C′_{(c′)}C″_{(c″)]}]O₁₂ wherein
   A represents at least one element selected from the group consisting of La, Y, Pr, Nd, Sm, Eu, Gd, Tb, Dy, Ho, Er, Tm and Yb;
   A′ represents at least one element selected from the group consisting of Ca, Sr, and Ba;
   A″ represents at least one element selected from the group consisting of Na and K;
   with 0≦a′<2 and 0≦a″<1
   B represents at least one element selected from the group consisting of Zr, Hf, and Sn;
   B′ represents at least one element selected from the group consisting of Ta, Nb, Sb, and Bi;
   B″ represents at least one element selected from the group consisting of Te, W, and Mo
   with 0≦b′≦2 and 0≦b″≦2;
   C′ represents at least one element selected from the group consisting of Al and Ga;
   C″ represents at least one element selected from the group consisting of Si and Ge;
   with 0≦c′≦0.5 and 0≦c″≦0.4
   and n=7+a′+2a″−b′−2b″−3c′−4c″ and 5.5≦n≦6.875 (or 5≦n≦7).
   Particular examples include but are not limited to: Li_{6.875}La₃Ta_{0.125}Zr_{1.875}O₁₂; Li_{6.75}La₃Ta_{0.25}Zr_{1.75}O₁₂; Li_{6.5}La₃Ta_{0.5}Zr_{1.5}O₁₂; Li_{6.25}La₃Ta_{0.75}Zr_{1.25}O₁₂; Li₆La₃TaZrO₁₂; Li_{5.5}La₃Ta_{1.5}Zr_{0.5}O₁₂; Al_{0.1}Li_{6.7}La₃Zr₂O₁₂; Al_{0.17}Li_{6.49}La₃Zr₂O₁₂; Al_{0.23}Li_{6.31}La₃Zr₂O₁₂; Al_{0.29}Li_{6.13}La₃Zr₂O₁₂; Al_{0.35}Li_{5.95}La₃Zr₂O₁₂; Al_{0.3}Li_{5.85}Sr_{0.25}La_{2.75}Nb_{0.5}Zr_{1.5}O₁₂; Si_{0.2}Li_{6.2}La₃Zr₂O₁₂
(ii) garnet-garnet-likelike compounds as described in U.S. Patent Application Pub. No.: 2011/0244337 having Kabushiki Kaisha Toyota Chuo Kenkyusho as assignee and inventors Ohta, Kobayashi, Asaoka, Asai, and which is herein incorporated by reference for the disclosure of these suitable garnet-like compounds:
   Li₅₊ₓLa₃(Zr_{X},A_{2-X})O₁₂ wherein
   A is at least one selected from the group consisting of Sc, Ti, V, Y, Nb, Hf, Ta, Al, Si, Ga, Ge, and Sn and X satisfies the inequality 1.4≦X<2; or
   A is one obtained by substituting an element having an ionic radius different from that of Zr for Zr sites in a garnet type lithium ion conducting oxide represented by the formula Li₇La₃Zr₂O₁₂.
(iii) garnet-like compounds as described in U.S. Pat. No. 8,092,941 having Werner Weppner as assignee and inventors Weppner and Thangadurai, and which is herein incorporated by reference for the disclosure of these suitable garnet-like compounds:
   Li₅₊ₓA_{y}G_{z},M₂O₁₂ wherein
   A is in each case independently a monovalent, divalent, trivalent, or tetravalent cation (e.g. A is an alkaline earth metal or transition metal such as Ca, Sr, Ba, Mg and/or Zn;
   G is in each case independently a monovalent, divalent, trivalent, or tetravalent cation (e.g. La);
   M is in each case independently a trivalent, tetravalent, or pentavalent cation;
   with 0<x≦3, 0<y≦3 and 0<z≦3 (e.g. a transition metal such as Nb, Ta, Sb and V); and
   O can be partially or completely replaced by divalent and/or trivalent anions such as e.g. N³⁻; and furthermore,
   within a structure of this formal composition L, A, G and M can each be the same or different.
   For example, Li₅₊ₓA_{y}G₃₋ₓ,M₂O₁₂ [such as Li₆ALa₂M₂O₁₂, e.g., Li₆ALa₂Ta₂O₁₂ (A=Sr, Ba)]
(iv) garnet-like compounds as described in U.S. Patent Pub. No.: 2011/0053002 having NGK Insulators, Ltd., as assignee and inventors Yamamura, Hattori, Yoshida, Honda, and Sato, and which is herein incorporated by reference for the disclosure of these suitable garnet-like compounds, for instance a ceramic material containing:
   (a) Li, La, Zr, Nb, O; or (b) Li, La, Zr, Ta, O; or (c) Li, La, Zr, Nb, Ta, O. For example, LiₐLa_{b}ZrₓM_{y}O_{c} wherein M represents the total number of moles of Nb and Ta, the molar ratios of the constitutive metal elements containing Nb and Ta can be set to be a:b:x+y:y=7:3:2:0.1 or greater to 0.6 or lower. In addition the ceramic material may contain Al (e.g., LiₐLa_{b}ZrₓM_{y}O_{c}zAl (wherein M represents the total number of moles of Nb and Ta and the molar ratios of the constitutive metal elements can be set to be a:b:x+y:z=7:3:2:0.025 or greater to 0.35 or lower.
(v) garnet like compounds as described in U.S. Patent Pub. No.: 2010/0203383 having BASF SE, as assignee and inventor Werner Weppner, and which is herein incorporated by reference for the disclosure of these suitable garnet-like compounds, for instance a compound having the general formula:
   Li₇₊ₓAₓG₃₋ₓZr₂O₁₂ wherein
   A is in each case independently a divalent cation (or combination of such cations, preferably divalent metal cations such as alkaline earth metal ions such as Ca, Sr, Ba, and/or Mg and also divalent cations such as Zn);
   G is in each case independently a trivalent cation (or combination of such cations, with preference given to La);
   with 0≦x≦3 (and preference is given to 0≦x≦2 and in particular 0≦x≦1); and
   O can be partly or completely replaced by divalent or trivalent anions such as N³⁻
(vi) nasicon like compounds as described in U.S. Pat. No. 4,985,317 having Japan Synthetic Rubber Co., Ltd. as assignee and inventors Adachi, Imanaka, Aono, Sugimoto, Sadaoka, Yasuda, Hara, Nagata, and which is herein incorporated by reference for the disclosure of these suitable garnet-like compounds, for instance a compound (sometimes referred to as LTP) having the general formula:

(a) Li₁₊ₓMₓTi₂₋ₓ(PO₄)₃ wherein

M is at least one element selected from the group consisting of Fe, Al and rare earth elements and x is a number from 0.1 to 1.9; or

(b) Li_{1+y}Ti₂Si_{y}P_{3-y}O₁₂ wherein y is a number from 0.1 to 2.9; or

(c) or some combination of (a) and (b)
(vii) lithium ion conductive compounds having the following composition:

| Composition | Mol % |
|---|---|
| P₂O₅ | 26-55% |
| SiO₂ | 0-15% |
| GeO₂ and TiO₂ | 25-50% |
| in which TiO₂ | 0-50% |
| in which GeO₂ | 0-50% |
| ZrO₂ | 0-10% |
| M₂O₃ | 0 < 10% |
| Al₂O₃ | 0-15% |
| Ga₂O₃ | 0-15% |
| Li₂O | 3-25% |

And in particular lithium ion conductive compounds having the following general formula:

Li₁₊ₓ(M,Al,Ga)ₓ(Ge_{1-y}Ti_{y})₂₋ₓ(PO₄)₃ where x≦0.8 and 0≦y≦1.0 and where M is an element selected from the group consisting of Nd, Sm, Eu, Gd, Tb, Dy, Ho, Er, Tm and Yb and/or Li_{1+x+y}QₓTi₂₋ₓSi_{y}P_{3-y}O₁₂ where 0≦x≦0.4 and 0≦y≦0.6 and where Q is Al or Ga. For example Li₍₁₊ₓ₎AlₓTi₂₋ₓ(PO₄)₃ where X is 0 to 0.8 as described in U.S. Pat. No. 5,702,995 having Kabushiki Kaisha Ohara as assignee and inventor Jie Fu, and which is herein incorporated by reference for the disclosure of these lithium ion conductive compounds.

Other suitable materials include glassy or amorphous metal ion conductors, such as a phosphorus-based glass, oxide-based glass, phosphorus-oxynitride-based glass, sulpher-based glass, oxide/sulfide based glass, selenide based glass, gallium based glass, germanium-based glass, Nasiglass; ceramic active metal ion conductors, such as lithium beta-alumina, sodium beta-alumina, Li superionic conductor (LISICON), Na superionic conductor (NASICON), and the like; or glass-ceramic active metal ion conductors. Specific examples include LiPON, Li₃PO₄.Li₂S.SiS₂, Li₂S.GeS₂.Ga₂S₃, Li₂O.11Al₂O₃, Na₂O.11Al₂O₃, (Na,Li)₁₊ₓTi₂₋ₓAlₓ(PO₄)₃ (0.1≦x≦0.9) and crystallographically related structures, Li₁₊ₓHf₂₋ₓAlₓ(PO₄)₃ (0.1≦x≦0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂ (M: rare earth such as Nd, Gd, Dy) Li₅ZrP₃O₁₂, Li₅TiP₃O₁₂, Li₃Fe₂P₃O₁₂ and Li₄NbP₃O₁₂, and combinations thereof, optionally sintered or melted. Suitable ceramic ion active metal ion conductors are described, for example, in U.S. Pat. No. 4,985,317 to Adachi et al., incorporated by reference herein in its entirety and for all purposes for the disclosure of these metal ion conductors.

A particularly suitable glass-ceramic material is a lithium ion conductive glass-ceramic having the following composition:

| Composition | mol % |
|---|---|
| P₂O₅ | 26-55% |
| SiO₂ | 0-15% |
| GeO₂ + TiO₂ | 25-50% |
| in which GeO₂ | 0-50% |
| TiO₂ | 0-50% |
| ZrO₂ | 0-10% |
| M₂O₃ | 0-10% |
| Al₂O₃ | 0-15% |
| Ga₂O₃ | 0-15% |
| Li₂O | 3-25% |

and/or such a material containing a predominant crystalline phase composed of Li₁₊ₓ(M,Al,Ga)ₓ(Ge_{1-y}Ti_{y})₂₋ₓ(PO₄)₃ where X=0.8 and 0=Y=1.0, and where M is an element selected from the group consisting of Nd, Sm, Eu, Gd, Tb, Dy, Ho, Er, Tm and Yb and/or Li_{1+x+y}QₓTi₂₋ₓSi_{y}P_{3-y}O₁₂ where 0<X=0.4 and 0<Y=0.6, and where Q is Al or Ga. The glass-ceramics are obtained by melting raw materials to a melt, casting the melt to a glass and subjecting the glass to a heat treatment. Such materials are available from OHARA Corporation, Japan and are further described in U.S. Pat. Nos. 5,702,995, 6,030,909, 6,315,881 and 6,485,622, incorporated herein by reference, for their disclosure of these lithium ion conductive materials.

Suitable solid-state ion conductor materials for the membrane include Li₆BaLa₂Ta₂O₁₂; Li₇La₃Zr₂O₁₂, Li₅La₃Nb₂O₁₂, Li₅La₃M₂O₁₂ (M=Nb, Ta)Li₇₋ₓAₓLa₃₋ₓZr₂O₁₂ where A may be Zn or another transition metal. These materials and methods for making them are described in U.S. Patent Application Pub. No.: 2007/0148533 (application Ser. No: 10/591,714) and is hereby incorporated by reference in its entirety and suitable garnet-like structures, are described in International Patent Application Pub. No.: WO/2009/003695, herein incorporated by reference for the disclosure of these suitable solid-state ion conductor materials.

The garnet structure can be modified by doping different elements so enhance performance such as chemical compatibility, ease of fabrication, reducing cost, and increasing conductivity. Particularly suitable substantially impervious garnet-like layers include modified garnet-like layers having compositions of about Li₆SrLa₂Ta₂O₁₂, Li₆BaLa₂Ta₂O₁₂, Li₆CaLa₂Nb₂O₁₂, Li₆SrLa₂Nb₂O₁₂, Li₆BaLa₂Nb₂O₁₂, Li₅La₃Bi₂O₁₂, Li₆SrLa₂Bi₂O₁₂, Li₅La₃Nb_{1.9}Y_{0.1}O12, Li₇La₃Hf₂O₁₂, Li_{6.55}La₃Hf_{1.55}Ta_{0.45}O₁₂, Li₅Nd₃Sb₂O₁₂, Li₇La₃Sn₂O₁₂, Li₇La₃Zr₂O₁₂, Li_{6.75}La₃Zr_{1.75}Nb_{0.25}O₁₂, Li_{6.25}La₃Zr₂Ga_{0.25}O₁₂, Li₇La₃Zr₂O₁₂ (LLZO) doped with Ge, Si, In, Al or some combination thereof

Continuing with reference to FIG. 1, the electroactive layer 112 has first and second major opposing surfaces. The first surface opposes the solid electrolyte membrane, but does not directly contact it, and the second surface opposes, in direct contact (i.e., touching contact), an anode current collector component 114, which is typically a dense metal layer (e.g., a nickel or copper foil) and preferably liquid impermeable.

The protected negative electrode further comprises a reservoir architecture 140 for accommodating liquid anolyte within the confines of the anode compartment 130. The reservoir architecture includes a composite porous material network 141 that is composed of discrete porous materials or mediums; including, a porous material interlayer 142, a porous-reservoir medium 144, and a porous inter-connecting material element 146. The network components are disposed in pore communication with each other. The inter-connecting element, as its name implies, directly contacts the porous material layer as well as the porous-reservoir medium and therewith provides pore communication there between. Notably, in this embodiment, the porous-reservoir medium and porous interlayer do not directly contact each other. The liquid anolyte is disposed within the pores of the network, and the pore structure of the network.

The porous material interlayer 142 may be a film coated onto the lithium foil 112, or otherwise positioned within the anode compartment 130 to cover the lithium foil first surface in direct contact. The porous material interlayer has interconnected pores for receiving and therein containing a liquid electrolyte, which, in direct and intimate contact with the lithium foil surface, provides a medium for the electrical migration of lithium ions into or out of the electro-active layer during operation of the cell. By intimate contact it is meant that the interface created therewith is sufficient to support facile electrical migration of lithium ions. On the other side of the interlayer is positioned the substantially impervious lithium ion-conducting solid electrolyte layer 132, positioned to cover, in direct contact, the porous interlayer 142. The corresponding porous interlayer surfaces are chemically compatible in direct contact with the lithium foil and solid electrolyte membrane respectively. Particularly suitable materials for use as a porous material film in direct contact with the lithium metal surface are polyolefin films, such as micro-porous polyethylene and/or polypropylene. The film may be coated directly onto the lithium metal surface, or more typically is a freestanding film (5-30 μm thick), such as a microporous separator.

Continuing with reference to FIG. 1, the second surface of the lithium electro-active layer is encapsulated in direct contact with the first surface of a current collector layer 114, which is preferably dense and liquid impermeable (e.g., a nickel foil), and the second surface of the current collector opposes the porous-reservoir medium 144 which, in this embodiment, is remotely positioned away from components on the other side of the current collector, and so it (the porous-reservoir medium) does not directly contact (i.e., directly touch) the lithium foil, the impermeable solid-state electrolyte layer, or the porous material interlayer. By use of the term remote it is meant that the referenced region or material component (e.g., the porous-reservoir medium) is disposed outside the confines of an interlayer region defined by the region bounded by, and therein existing between, the electroactive layer and the solid electrolyte membrane.

Electrical contact between the current collector layer 114 and the negative electrode cover plate 136 can be made by any suitable method including the use of an electronically conducting connector component 116, which is internal to the interior of the cell, such as a metal clip or ribbon like metal layer that attaches (e.g., welded or spring loaded) to the electronically conductive current collector layer and the electronically conductive portion of the negative electrode cover, and, moreover, in this embodiment, said cover serves as the feedthrough terminal through which electronic contact is made to the exterior of the cell (e.g., for connection to a second cell or to a device). The porous-reservoir medium, similar to the material interlayer on the lithium surface, is constructed to receive non-aqueous liquid anolyte and therein to contain a certain amount of non-aqueous electrolyte, typically sufficient to fill the total volume of through pore space in the reservoir medium. Moreover, albeit the reservoir medium and material film do not directly contact, the two discrete components are nonetheless disposed in pore communication via the porous inter-connecting material element 146.

In order for the reservoir architecture to function properly, and preferably enhance electrode performance, the respective pore surfaces of each porous material component (e.g., the porous material interlayer, the porous-reservoir medium, and (when present) the porous inter-connecting material element) should be readily wet-able (i.e., easily wetted) by the liquid anolyte. Wettability of a pore surface by the liquid anolyte is an important characteristic of the architecture. The term “wetting”, “wetted” or “wettability” is generally used to describe the ability of a liquid to spread on a solid surface, and, in the case of a porous solid body, the ability of the liquid to displace a gaseous phase and imbibe the through-pores with the wettable liquid. Accordingly, when describing the wettability of a porous solid body consideration should be given to the nature of both the solid material from which the pore surface is composed as well as the liquid phase with which it (the pore surface) may or may not be readily wetted by. As used herein a liquid is referred to as wettable if it readily wets or spreads over a solid surface or readily imbibes a porous solid body. A wettable liquid will flood a solid porous body provided sufficient liquid is present to fill all the pores. A non-wettable liquid resists spreading over a solid surface or imbibing a porous body, and, moreover, in the presence of excess liquid, a non-wettable liquid will not flood a porous body, as the non-wetting pore surfaces resist the liquid from displacing the gas phase. For example, in various embodiments the readily wet-able porous material component(s) of the protected electrode architecture have a contact angle with the liquid anolyte that is less than 90° (i.e., readily wet-able), and in certain embodiments less than 60° or less than 30°.

With reference to FIG. 1 the composite porous material network is composed of the porous-reservoir medium 144, the porous material interlayer 142, and the porous inter-connecting element 146 each discrete porous material components, each typically having a different pore structure (i.e., total porosity, pore volume, and pore size distribution). As shown in FIG. 1, the discrete interlayer and discrete reservoir medium do not directly contact each other (i.e., they do not touch), but are nonetheless in pore communication via the inter-connecting element.

In other embodiments, as described in more detail below, the interlayer may be positioned in direct contact with the reservoir medium, and the area portion of their respective major surfaces over which said discrete porous components come into direct contact is typically significant; for instance, 80-95% (e.g., 80-90% or 90-95%) of the area of the major surfaces are positioned to be in direct contact. In yet other embodiments, the area over which the major surfaces of the discrete porous material interlayer and that of the discrete reservoir medium directly contact is less than 50%, and in particular embodiments it is between 10-30% (e.g., 10-20% or 20-30%).

Moreover, the invention is not limited to discrete porous components, and it is contemplated herein, that at least two of said porous material components may be of a unitary construction, which is to mean that the components are distinguishable by their pore structure, but otherwise composed of a single unitary material. The unitary structure may have a continuously graded pore structure or the unitary structure may have two or more different pore structure regions with a distinct boundary there between. For instance, the interconnecting media may be part of a unitary structure in conjunction with the reservoir or in conjunction with the material film, or all three components may be a unitary structure.

In accordance with the invention, the porous material network is engineered to have pore radii increasing in the direction away from the interface with the material film, and as such its pore structure preferably creates a sufficient capillary force to drive redistribution of the liquid anolyte, and in particular preferably: i) drives liquid anolyte from the large pores of the reservoir medium to the smaller pores of the material interlayer, the smaller pores of the material interlayer on or nearby the lithium metal surface; ii) displaces liquid anolyte from the reservoir medium into the interlayer as a result of gas diffusion into the large pores of the reservoir medium; iii) displace liquid anolyte from the reservoir medium into the interlayer due to the formation of solid reaction product(s) between the lithium metal foil and the liquid anolyte composition, and their preferential deposition into the large pores of the reservoir (at least when the reaction products break free from the lithium).

The total porous volume of the porous-reservoir medium, and/or that of the reservoir structure, may be significantly larger than the total pore volume of the interlayer adjacent to the lithium surface. In various embodiments, the total porous volume of the reservoir medium is between 30-100% greater than the total pore volume of the interlayer (e.g., about 30%, about 50%, about 100%). In other embodiments the relative pore volume factor is even greater. For instance, the total porous volume of the reservoir medium is between 200%-1000% greater than the total pore volume of the interlayer (e.g., about 1000%), and in some embodiments, larger than that, for instance at least 1000%.

In accordance with the invention a significant fraction of the total pore volume of the porous-reservoir medium is derived from relatively large pores (i.e., pores having a relatively large pore radii) compared to the pores in the material interlayer. For instance, as it pertains to the range of pore sizes, the radii of pores constituting at least 80-95% (e.g., 80-90% or 90-95%) (of the total pore volume of the reservoir medium are larger than the pore radii constituting at least 80-95% (e.g., 80-90% or 90-95%) of the material interlayer's total pore volume. More particularly, as it pertains to the ratio of pore sizes, the radii of pores constituting at least 80-95% (e.g., 80-90% or 90-95%) of the reservoir medium total pore volume are a certain factor larger than the radii of pores constituting at least 80-95% (e.g., 80-90% or 90-95%) of the interlayer total pore volume. In various embodiments said factor is a factor of 2 times larger, or 10 times larger, or 100 times larger, or 1000 times larger.

In various embodiments the porous material interlayer is relatively thin and has a thickness in the range of 5 to 50 μm (e.g., 10-30 μm). Particular films have a thickness of about 5 μm, about 10 μm, about 15 μm, about 20 μm, about 25 μm, and about 30 μm. However, thinner porous material films are contemplated (e.g., less than 5 μm), such as about 1 μm, about 2 μm, about 3 μm, or about 4 μm.

Continuing with reference to FIG. 1, it is preferable that the interior region of the anode compartment nearby the inter-connecting porous element 146, and in particular regions between the inter-connecting porous element and the reservoir medium and the inter-connecting porous element and the porous interlayer, be devoid of empty volume (i.e., gaps), which, if present, would entirely fill with evolving gas or solid reaction product and as a result block anolyte flow within the porous network (i.e., prevent flow of anolyte between the material film and the reservoir). Accordingly, the porous inter-connecting element(s) should have a significant fraction of its pore radii larger than a significant fraction of the material interlayer pore radii and smaller than a significant fraction of the reservoir medium pore radii. For instance, 80-95% (e.g., 80-90% or 90-95%) of the pore radii which constitute the total pore volume of the inter-connecting element are larger than 80-95% (e.g., 80-90% or 90-95%) of the pore radii which constitute the total pore volume of the material interlayer and are smaller than 80-95% (e.g., 80-90% or 90-95%) of the pore radii which constitute the total pore volume of the reservoir medium. In particular embodiments, substantially all of the pores of the inter-connecting element have radii larger than the pore radii of substantially all of the pores of the material interlayer and substantially all of the pores of the inter-connecting element have radii smaller than the pore radii of substantially all of the pores of the material interlayer.

To facilitate redistribution of solid product away from the lithium metal surface, the solid products, which may form as a result of electrochemistry, preferably have at least a finite solubility in the liquid anolyte. For instance, a solubility of between 0.1 μM-1 mM (e.g., 0.1 μM-1 μM; 1 μM-10 μM; 10 μM-100 μM). Moreover, to further facilitate redistribution of solid product it is preferable that the interface energy between the solid product and the pore wall surfaces of the porous material film are smaller than that of the liquid anolyte in contact with the pore wall surfaces of the porous material interlayer, which, in conjunction with the aforementioned finite solubility in the anolyte, will eventually lead to redistribution of the solid product into the reservoir medium, which, due to its pore size distribution compared to the material interlayer and inter-connecting element (when present), is the thermodynamically favorable location for solid product to precipitate.

Particularly suitable materials for use as the porous reservoir medium and porous inter-connecting material element include polymeric materials (e.g., polyolefins) as well as silicone foams with open porosity, ceramic felts such as zirconia, alumina, ceria, magnesia felts, or more generally metal oxide porous structures, as well as, graphite felts and carbonaceous porous materials. Moreover, the porous-reservoir medium and/or porous inter-connecting element may be, and in various embodiments is/are, chemically incompatible in direct contact with the electroactive lithium layer. For instance, in certain embodiments the material of the reservoir medium is chemically incompatible with lithium metal, the materials adversely reacting in direct contact. For such said embodiments, the adverse reaction is inhibited, as the lithium metal surface is protected on its surface by the porous interlayer, which thereon prevents direct contact of the other porous solid components of the network.

Continuing with reference to FIG. 1, the positive electrode 150 includes a cathode layer 152 having a first and second surface. The cathode layer may contain cathode electroactive material, or the cathode layer may be a porous electron transfer medium and the cathode electroactive material contained in a catholyte in direct contact with the cathode layer. The first surface of the cathode layer opposes the solid electrolyte membrane. In various embodiments an optional porous separator layer may be incorporated between the membrane and the cathode layer, or the cathode layer may be in direct contact with the membrane. The second surface of the cathode layer opposes a positive electrode cover plate 154, which in the instant embodiment also serves as a current collector and positive electrode feedthrough component. Moreover, the cover plate hermetically interfaces with sidewall 132 to define a cathode compartment wherein the cathode layer and optional catholyte is disposed. In accordance with this embodiment the sidewall component serves as both the cathode electrode sidewall and negative electrode sidewall, and thus may be a contiguous unitary cell sidewall.

Without limitation, suitable liquid anolytes include that which contains a solvent selected from the group consisting of organic carbonates, ethers, lactones, sulfones, etc, and combinations thereof, such as EC, PC, DEC, DMC, EMC, 1,2-DME or higher glymes, THF, 2MeTHF, sulfolane, ionic liquids (as are known in the art) and combinations thereof. 1,3-dioxolane may also be used as an anolyte solvent, particularly but not necessarily when used to enhance the safety of a cell incorporating the structure, as described further below. Generally the anolyte should be chemically compatible in contact with the active metal anode, and in this regard may include compatible liquid solvents (i.e., those which are solely compatible) as well as those solvents which are not compatible by themselves but in combination with a suitable electrolytic salt and/or additional solvent(s) leads to a chemically compatible anolyte. Such liquid solvents (solely chemically compatible or otherwise) may include organic or inorganic solvents such as those described above, as well as ionic liquid solvents. For instance the chemically compatible anolyte may be composed of an ionic liquid in combination with non-aqueous organic liquid solvent(s) and an optional salt. Suitable anolytes will also, of course, also include active metal salts, such as, in the case of lithium, for example, LiPF₆, LiBF₄, LiAsF₆, LiSO₃CF₃ or LiN(SO₂C₂F₅)₂.

As described in U.S. Pat. No. 8,332,028, other anolyte solvents including ionic liquids, and especially non-aqueous organic ionic liquids, as well as inorganic ionic liquids that are sufficiently compatible in contact with the lithium electroactive layer (e.g., lithium metal or lithium intercalation material, such as carbon) may be used as anolyte herein. Ionic liquids are a subclass of non-aqueous solvents and are generally known in the battery art for their use as an electrolyte component. Ionic liquids generally suitable for use herein are preferably liquids at room temperature, although the invention is not limited as such, and organic salts having melting points below 100° C. are generally contemplated for use in warm temperature battery cells. Ionic liquids are known in the art, including those based on imidazolium and pyrrolidinium. The ionic liquids will generally contain a lithium salt, such as those having a TFSI anion.

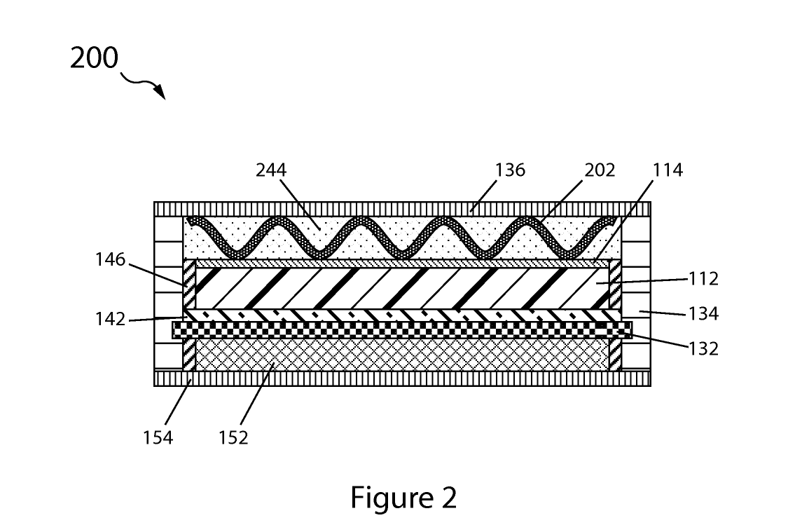

With reference to FIG. 2 there is illustrated another embodiment of a single-sided protected lithium electrode 210 and battery cell 200 in accordance with the instant invention. In this embodiment the porous material network is composed a porous material interlayer 142 and an interconnecting element 146 as described above, and an open-space reservoir 244 filled with liquid anolyte but devoid of a porous-reservoir medium. Moreover, the liquid anolyte in the reservoir is in liquid flow communication with the liquid anolyte in the interlayer via the interconnecting element. The pore structure of the network is similar to that described above with reference to protected electrode 110. The open-space reservoir includes a spring or elastic material component 202 for providing pressure against the lithium current collector, and this for the purpose of maintaining sufficient contact between internal components, including contact of the porous material interlayer with the lithium foil and with the solid electrolyte membrane, as well interface contact within the positive electrode compartment. The spring provides internal cell pressure, and in such embodiments the anode cover plate is typically rigid.

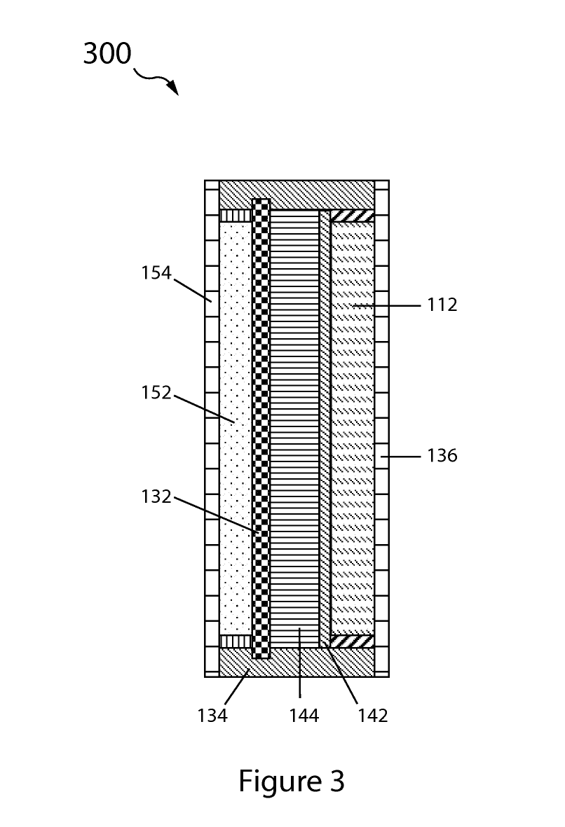

With reference to FIG. 3 there is illustrated another embodiment of a single-sided protected lithium electrode 310 and battery cell 300 in accordance with the instant invention. In this embodiment the porous material network includes a porous-reservoir medium 344 disposed within the interlayer region (as defined above). The porous-reservoir medium positioned between and in direct contact (i.e., touching contact) with the porous interlayer material 142 and the solid electrolyte membrane 132. In various embodiments the porous-reservoir medium is typically at least twice as thick as the porous interlayer. The porous-reservoir medium does not contact the lithium metal surface, but is present within an interlayer region defined by the region between the substantially impervious solid electrolyte layer and the electroactive layer, and therefore, in this embodiment, the reservoir medium is not remotely positioned, as defined above. This can be held in stark contrast to the cell embodied in FIG. 1, wherein the reservoir medium, not disposed in the interlayer region, is remotely positioned from the porous material film as well as the lithium metal foil.

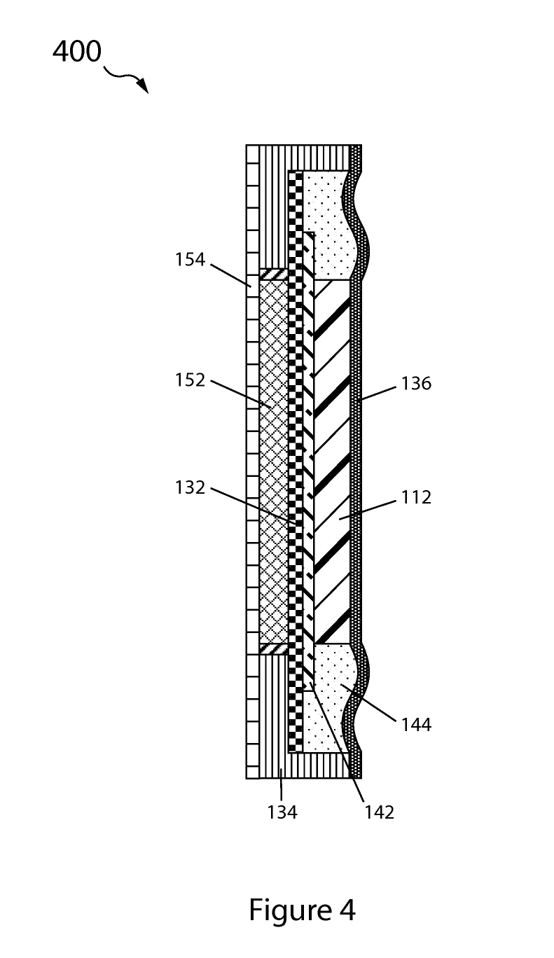

With reference to FIG. 4 there is illustrated another embodiment of a battery cell 400 and a protected lithium electrode 410 in accordance with the instant invention. Therein the porous-reservoir medium 444 is positioned outside the interlayer region (and therefore is remote or remotely positioned), but wholly disposed about the periphery of the anode compartment (and the lithium metal layer), and thus it is unnecessary to utilize a discrete porous interconnecting element, because the material interlayer directly contacts the liquid anolyte contained in the peripheral reservoir medium.

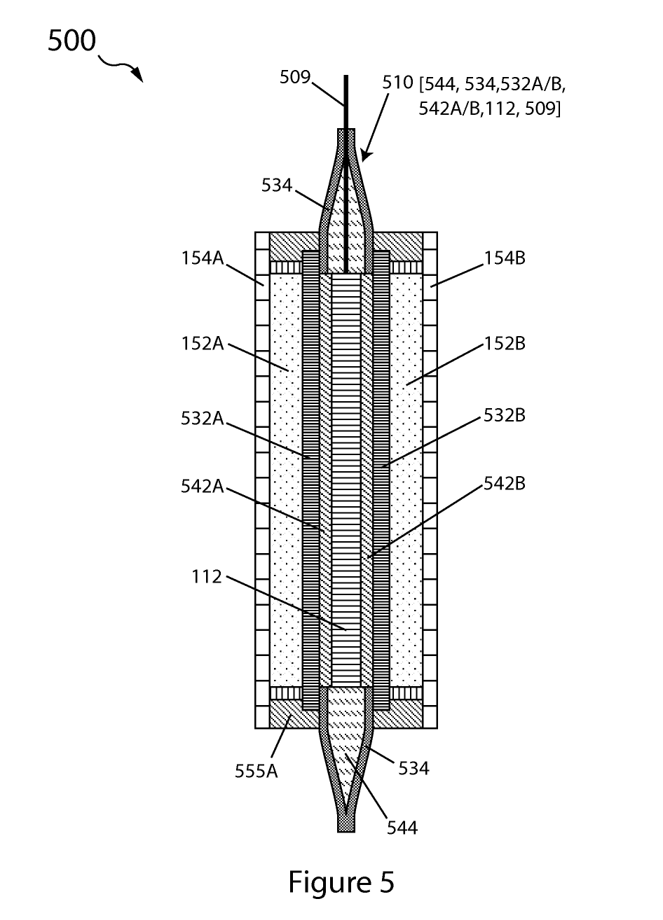

With reference to FIG. 5 there is illustrated another embodiment of a battery cell 500 and a protected active metal negative electrode 510 in accordance with the instant invention. Therein the cell 500 includes a double-sided protected negative electrode 510 having a first and second solid electrolyte membrane 532A/532B, a first and second material interlayer 542A/542B and a flexible sidewall 534 for sealing the sides of the anode compartment. The sidewall is flexible and therefore compliant to changes in anode thickness. Moreover, in accordance with this embodiment the flexible sidewall 534 hermetically interfaces with the rigid positive electrode sidewalls 555A/555B, such that the cell as a whole is also compliant to changes in anode thickness. Continuing with reference to FIG. 5, the reservoir architecture utilizes an open space reservoir 544 positioned about the periphery of the electroactive layer and is defined by the walls of the flexible sidewall itself. In various embodiments the first and second material interlayers may extend into the reservoir to enhance capillary pull. Double-sided protected lithium electrodes having flexible compliant seals are also described in Applicant's U.S. Pat. No. 8,048,570, hereby incorporated by reference for its disclosure of these protected electrode structures. The protected electrode 510 further includes an electrical feedthrough component 509 for providing an electronic pathway into and out of the anode compartment.

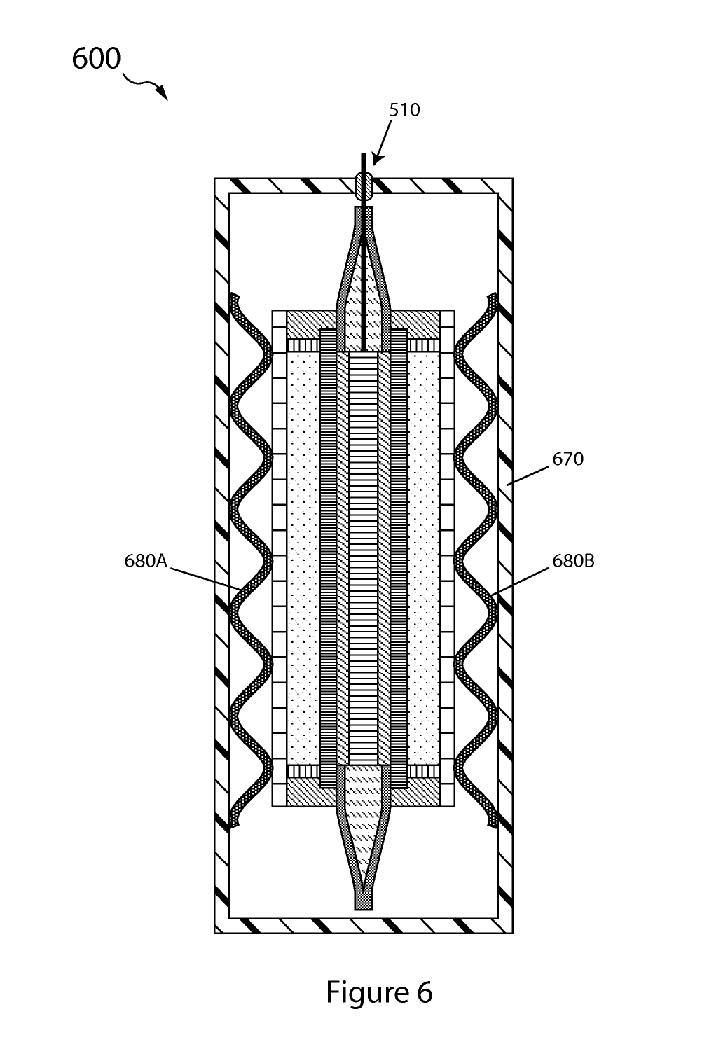

With reference to FIG. 6 there is illustrated another embodiment of a battery cell 600 in accordance with the instant invention, and therein having a double-sided protected anode 510 as described immediately above. Cell 600 includes a rigid outer frame 670 and external springs 680A/680B that are located within the interior of the external frame for providing positive pressure onto the cell as a whole. The rigid outer frame generally composed of a polymeric material such as polyethylene.

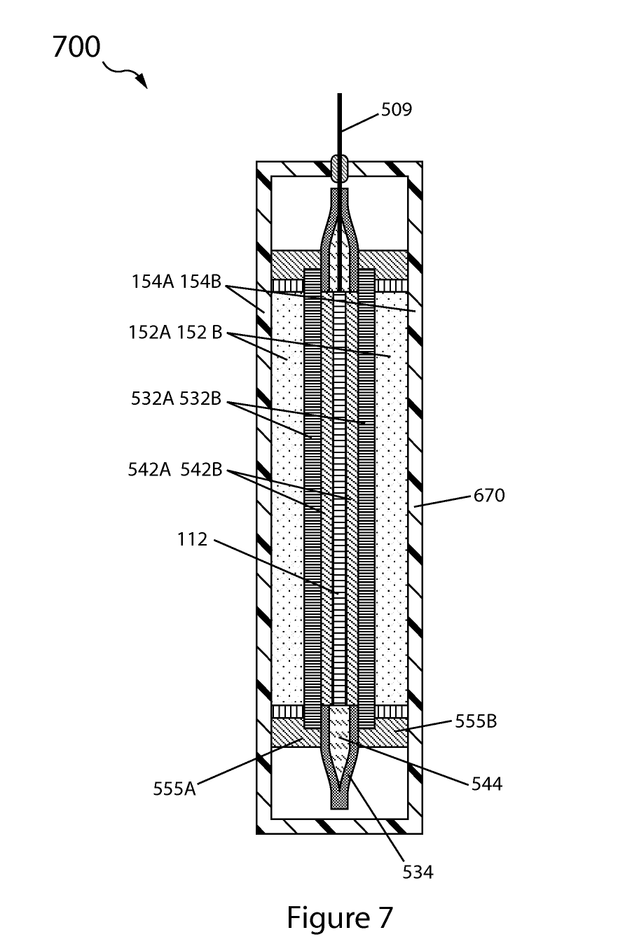

With reference to FIG. 7 there is illustrated another embodiment of a battery cell 700 in accordance with the instant invention, and therein having a double-sided protected anode 510 as described above. Cell 700 includes a rigid outer frame 670 adhered to the positive electrode sidewalls, and the frame provides both the first and second positive electrode cover plates, which also function as positive electrode current collectors and electronic feedthroughs. Accordingly, the frame is electrically conductive in the regions for which it is to provide current collection and electronic feedthrough functionality.

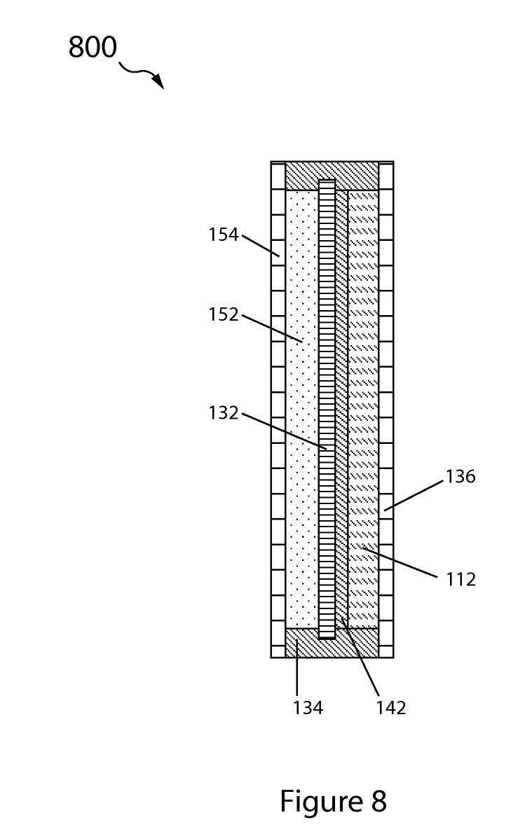

With reference to FIG. 8 there is illustrated another embodiment of a battery cell 800 in accordance with the instant invention. Therein the cell 800 is configured to include a single-sided protected anode wherein the anode compartment includes a seal between the solid electrolyte membrane and the rigid anode sidewall. This embodiment is particularly suitable when using a lithium electro-active layer that undergoes a nominal volume change as a result of each cycle, such as a lithium intercalation material layer, especially a carbon intercalation electrode, such as is known for use in conventional lithium ion battery cells.

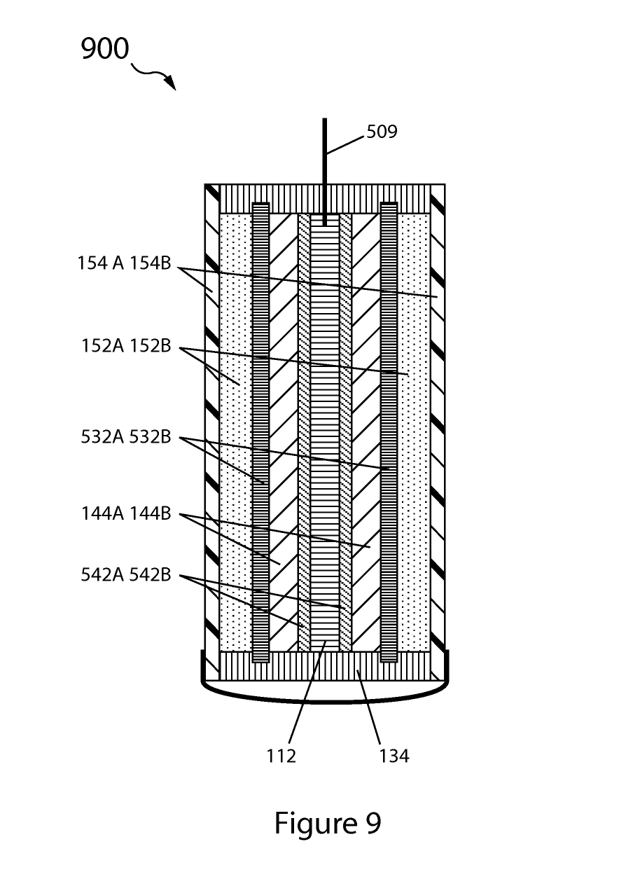

With reference to FIG. 9 there is illustrated another embodiment of a battery cell 900 and a protected active metal negative electrode in accordance with the instant invention. Therein the cell is configured with a double-sided protected anode combined with a unitary contiguous sidewall that serves as the sidewall for both of the anode compartments as well as the cathode compartment. The double-sided anode compartments make use of a seal between their respective solid electrolyte membranes and the rigid sidewall to fully isolate the lithium foil, via the seal (e.g., an epoxy seal). The protected lithium electrode 910 has two anode compartments, and accordingly includes a pair of porous material networks, each having an interlayer and a porous-reservoir medium disposed within the interlayer region of their respective anode compartments.

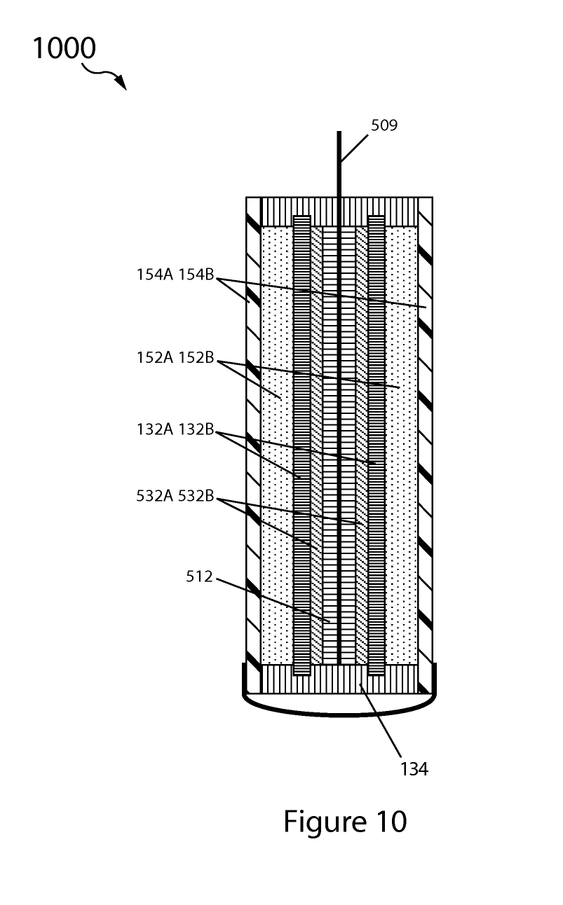

With reference to FIG. 10 there is illustrated another embodiment of a battery cell 1000 in accordance with the instant invention. Therein the cell is especially configured for a lithium electro-active layer that undergoes a nominal volume change as a result of each cycle, and preferably a nominal volume change as a result of cycling over the lifetime of the cell. For such cells, the lithium electro-active layer is preferably based on intercalation materials, such as carbon intercalation materials; e.g., the electro-active layer a carbon intercalation based electrode as is well known for its use in the lithium ion battery field. In the instant embodied cell, the anode compartment is double-sided as described above, and the porous material networks are based solely on porous material interlayers disposed between their respective solid electrolyte membranes and carbon electro-active layers, the interlayer in direct contact with the electroactive layer.

The invention is not limited to a particular type of cathode electroactive layer or to a type of catholyte; both aqueous and non-aqueous are contemplated. In particular embodiments, the aforesaid cathode layer is a porous electron transfer medium containing liquid polysulfide catholyte (e.g., aqueous or non-aqueous catholyte), as described in Applicant's U.S. Pat. Nos: 8,828,575; 8,828,574; 8,828,573 which are hereby incorporated by reference for the teachings of this cathode layer. However, the invention is not limited as such and other types of cathode layers are contemplated including lithium ion type cathode layers that are based on positive electrode intercalation materials.

Conclusion

Various embodiments of the invention have been described. However a person of ordinary skill in the art will recognize that various modifications may be made to the described embodiments without departing from the scope of the claims. Accordingly, the present embodiments are to be considered as illustrative and not restrictive, and the invention is not to be limited to the details given herein.

What is claimed is:

1. A protected active metal negative electrode, comprising:
a) an active metal electroactive layer having first and second opposing surfaces;
b) a negative electrode cover plate component having first and second major opposing surfaces, the cover plate first surface opposing the second surface of the electroactive layer;
c) a substantially impervious active metal ion conductive solid electrolyte membrane having first and second opposing surfaces, the first membrane surface opposing the first electroactive layer surface;
d) a liquid phase anolyte in direct contact with the electroactive layer and the membrane;
e) a peripheral negative electrode sidewall component surrounding the periphery of the electroactive layer, the sidewall component configured to interface with the cover plate component and solid electrolyte membrane component to define an electrochemically functional hermetic anode compartment wherein the liquid anolyte and electroactive layer are disposed and therein isolated from direct contact with the external environment about the anode compartment, and further wherein the solid electrolyte membrane provides an ionic pathway for active metal ion communication into and out of the anode compartment;
f) an optional current collector layer having first and second opposing surfaces, the first current collector surface adjacently disposed in direct contact with the second electroactive layer surface;
g) an electronically conductive feedthrough component in electronic communication with the electroactive layer, wherein the feedthrough component provides an electronic pathway for the through conduction of electrons into and out of the anode compartment; and
h) a liquid anolyte reservoir architecture disposed within the interior of the anode compartment and therein configured for accommodating liquid anolyte within the anode compartment, the architecture having a spatially engineered pore structure that: i) drives liquid anolyte toward the first surface of the electroactive layer and ii) drives solid and/or gaseous reaction products away from the first surface of the electroactive layer, the liquid anolyte reservoir architecture comprising:
i) a porous material network that is devoid of electroactive material, the network comprising a porous material interlayer component comprising a first amount of liquid anolyte, the interlayer adjacently disposed between the electroactive layer and the solid electrolyte membrane and in direct contact with the first surface of the electroactive layer; and
ii) a reservoir comprising a second amount of liquid anolyte that is in flow communication with the anolyte of the interlayer.

2. The protected electrode of claim 1, wherein the volume of liquid anolyte in the anode compartment is greater than the combined total pore volume of the first-network and second-network porous interlayer components.

3. The protected electrode of claim 1, wherein the second amount of liquid anolyte in the reservoir is greater than the total pore volume of the interlayer, such that the second amount of anolyte is greater than the first amount.

4. A battery cell, comprising:
a protected negative active metal electrode as described in claim 1; and,
further comprising:
a porous positive electrode layer comprising an optional current collector in direct contact with the positive electrode layer;
an optional liquid catholyte component;
an optional separator component;
a positive electrode backplane component
a positive electrode feedthrough component; and
a peripheral positive electrode sidewall component surrounding the periphery of the positive electrode, the sidewall configured to interface with the positive electrode backplane and negative electrode sidewall to define a cathode compartment wherein the positive electrode layer, optional liquid catholyte and optional separator component are disposed; and further wherein the positive electrode feedthrough component is configured to provide electronic communication between the interior and the exterior of the cathode compartment.

5. A double-sided protected active metal negative electrode, the electrode comprising:
a) an active metal electroactive layer having first and second major opposing surfaces;
b) a first and second substantially impervious active metal ion conductive solid electrolyte membrane, each membrane having first and second major opposing surface, the first-membrane first-surface opposing the electroactive layer first-surface and the second-membrane first-surface opposing the electroactive layer second-surface;
c) a liquid phase anolyte in direct contact with the electroactive layer first-surface, the electroactive layer second-surface, the first-membrane first-surface and the second-membrane second-surface;
d) a peripheral negative electrode sidewall component surrounding the periphery of the electroactive layer, the sidewall component configured to interface with the first-membrane and the second-membrane components to define an electrochemically functional hermetic anode compartment wherein the liquid anolyte and electroactive layer are disposed and therein isolated from direct contact with the external environment about the anode compartment, and further wherein each solid electrolyte membrane provides an ionic pathway for active metal ion communication into and out of the anode compartment;
e) an optional current collector layer disposed within the midplane of the electroactive layer, and therein directly contacting the electroactive layer;
f) an electronically conductive feedthrough component in electronic communication with the electroactive layer and the current collector when present;
g) a liquid anolyte reservoir architecture disposed within the interior of the anode compartment and therein configured for accommodating liquid anolyte within the interior of the compartment, the architecture having a spatially engineered pore structure that: a) drives liquid anolyte toward the first and second surfaces of the electroactive layer and b) drives solid and/or gaseous reaction products away from the surface of the electroactive layer, the liquid anolyte reservoir architecture comprising: i) a first and second porous material network comprising liquid anolyte; and ii) a reservoir comprising liquid anolyte;
i) wherein the first porous material network comprises a first-network porous interlayer component comprising liquid anolyte, the first-network porous interlayer positioned in direct contact with the electroactive layer and adjacently disposed between the electroactive layer first-surface and the first-membrane first-surface; and
ii) wherein the second porous network comprises a second-network porous interlayer component comprising liquid anolyte, the second-network porous interlayer positioned in direct contact with the electroactive layer and adjacently disposed between the electroactive layer second-surface and the second-membrane first surface;
iii) wherein the liquid anolyte in the reservoir is in flow communication with the liquid anolyte disposed in the first-network porous interlayer component and/or the liquid anolyte disposed in the second-network porous interlayer component.

6. The protected electrode of claim 4, wherein the volume of liquid anolyte in the anode compartment is greater than the combined total pore volume of the first-network and second-network porous interlayer components.

7. The protected electrode of claim 5, wherein the volume of liquid anolyte in the reservoir is greater than the combined total pore volume of the first-network and second-network porous interlayer components.

8. A battery cell, comprising:
a double-sided protected negative electrode as described in claim 5; and
further comprising:
a first and second positive electrode layer each comprising an optional current collector in direct contact;
an optional liquid catholyte;
an optional separator component;
a first and second positive electrode backplane component;
a first and second positive electrode feedthrough component;
a first and second peripheral positive electrode sidewall component surrounding the periphery of their respective positive electrode layer, the sidewalls configured to interface with their respective backplane components to define a first and second cathode compartment wherein the first and second positive electrode layer and optional catholyte and optional separator are disposed; and
further wherein the positive electrode feedthrough components are configured to provide electronic communication between the interior and the exterior of their respective cathode compartments; and
even further wherein the first and second positive electrode sidewall components are rigid and configured to hermetically interface with the compliant negative electrode sidewall, such that the cathode compartments and the anode compartments are conjoined such that the cell thickness is compliant to changes in the thickness of the anode compartment.
